(19) United States
(12) Patent Application Publication
(10) Pub. No.: US 2017/0011640 A1
(43) Pub. Date: Jan. 12, 2017

(54) System For Monitoring, Processing, Analyses And Storage Of Physiological Signals For Emotion Recognition

(71) Applicant: Genaro Rebolledo-Mendez, Coatepec (MX)

(72) Inventor: Genaro Rebolledo-Mendez, Coatepec (MX)

(21) Appl. No.: 14/794,767

(22) Filed: Jul. 8, 2015

(51) Int. Cl. G09B 5/00

(52) U.S. Cl. CPC G09B 5/00

(57) ABSTRACT

A system for monitoring, processing, analyses and storage of physiological signals for emotion recogni for offering users the possibility of automatically recognizing human emotions during the course of an activity based on user's bio-signals and offering a prediction based on the automatically recognized emotion and past emotions stored in a data warehouse and offering a link to other products, services and applications to exploit said human emotions. The system for monitoring, processing, analyses and storage of physiological signals for emotion recogni generally includes a bio transmitter, an online system for processing of bio-signals into emotions and predictions, an emotion transmitter and an emotion query system.

### BACKGROUND OF THE INVENTION

The present invention relates generally to and more specifically it relates to a system for monitoring, processing, analyses and storage of physiological signals for emotion recogni for offering users the possibility of automatically recognizing human emotions during the course of an activity based on user's bio-signals and offering a prediction based on the automatically recognized emotion and past emotions stored in a data warehouse and offering a link to other products, services and applications to exploit said human emotions.

### BRIEF SUMMARY OF THE INVENTION

The invention generally relates to an automatic recognition and prediction of emotions which includes a bio transmitter, an online system for processing of bio-signals into emotions and predictions, an emotion transmitter and an emotion query system.

There has thus been outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide a system for monitoring, processing, analyses and storage of physiological signals for emotion recogni for offering users the possibility of automatically recognizing human emotions during the course of an activity based on user's bio-signals and offering a prediction based on the automatically recognized emotion and past emotions stored in a data warehouse and offering a link to other products, services and applications to exploit said human emotions.

Another object is to provide a System For Monitoring, Processing, Analyses And Storage Of Physiological Signals For Emotion Recogni that collect bio-signals generated in one or multiple users via a bio transmitter comprising data collection mechanisms from one or multiple bio sensors.

Another object is to provide a System For Monitoring, Processing, Analyses And Storage Of Physiological Signals For Emotion Recogni that uses wired and wireless online mechanisms to receive the bio-signals generated by said bio transmitter.

Another object is to provide a System For Monitoring, Processing, Analyses And Storage Of Physiological Signals For Emotion Recogni that uses mechanisms to clean said bio-signals to produce data.

Another object is to provide a System For Monitoring, Processing, Analyses And Storage Of Physiological Signals For Emotion Recogni that stores said data in a data warehouse for later query and retrieval via an emotion transmitter and an emotion query system comprising mechanisms to query and retrieve said data using wired or wireless online protocols providing on demand capabilities (cloud computing).

Another object is to provide a System For Monitoring, Processing, Analyses And Storage Of Physiological Signals For Emotion Recogni that analyses said data to estimate user's emotions and a prediction of user's emotions based on current and historical data stored on said data warehouse.

Another object is to provide a System For Monitoring, Processing, Analyses And Storage Of Physiological Signals For Emotion Recogni that storages said emotions and said predictions in said datawarehouse.

Another object is to provide a System For Monitoring, Processing, Analyses And Storage Of Physiological Signals For Emotion Recogni that provide mechanisms for retrieval and communication of said emotions and said prediction stored on said data warehouse via an emotion transmitter and an emotion query system comprising mechanisms to retrieve and communicate said emotions to provide an on demand service via the Internet (cloud computing).

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1: FIG. 1 is a flowchart illustrating the overall operation of the present invention. The flowchart describes the system for automatic recognition, storage and transmission of user's emotions.

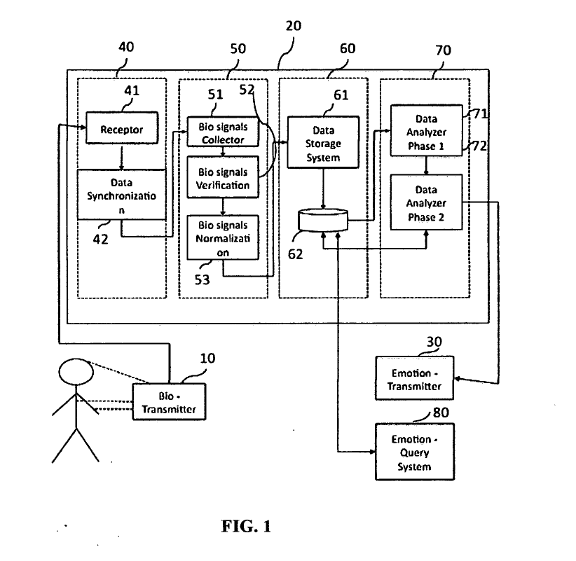

FIG. 2: FIG. 2 is a block diagram illustrating the overall of the present invention. This figure shows the overall operation of the system for automatic recognition, storage and transmission of user's emotions.

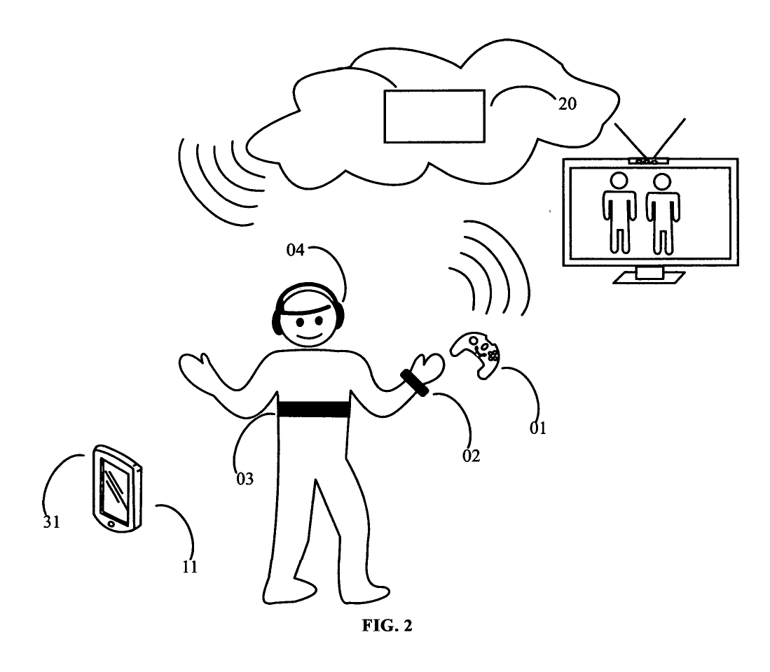

FIG. 3: FIG. 3 is a first alternative embodiment of the present invention. Diagram showing the first preferred embodiment for reaction of objects depending on automatic recognition, storage and transmission of user's emotions.

FIG. 4: FIG. 4 is a second alternative embodiment of the present invention. Diagram showing the second preferred embodiment for reaction of objects depending on automatic recognition, storage and transmission of user's emotions.

FIG. 5: FIG. 5 is a third alternative embodiment of the present invention. Diagram showing the third preferred embodiment for reaction of objects depending on automatic recognition, storage and transmission of user's emotions.

FIG. 6: FIG. 6 is a fourth alternative embodiment of the present invention. Diagram showing the fourth preferred embodiment for reaction of objects depending on automatic recognition, storage and transmission of user's emotions.

FIG. 7: FIG. 7 is a flowchart illustrating the overall operation of the present invention. Diagram describing the functionality of the Emotion Query System.

### DETAILED DESCRIPTION OF THE INVENTION

### A. Overview

Turning now descriptively to the drawings, in which similar reference characters denote similar elements throughout the several views, the figures illustrate a bio transmitter, an online system for processing of bio-signals into emotions and predictions, an emotion transmitter and an emotion query system.

### B. Bio Transmitter

Comprises mechanisms to collect bio-signals from one or multiple bio sensors generated in one or multiple users.

The bio transmitter (10) comprises methods that collect data from bio-signals monitoring inventions comprising user's heart rate, blood pressure, temperature, electro dermal activity and/or brain activity to transmit these signals to the online processing system (20) over the Internet.

The bio transmitter (10) comprises software components in the form of applications for for electronic telecommunication portable devices that constantly monitor bio-signals monitoring inventions reading user's bio-signals and acquires, compresses and transmits said bio-signals to the online processing system (20) via the Internet.

### C. Online Processing System

Comprising sub processes for a) receiving bio-signals (40) b) cleaning bio-signals to produce data (50) c) storing data in data warehouse (60) d) analysing data to estimate user's emotions (71) and a prediction of user's emotions (72) e) storing both emotions and predictions in data warehouse (70).

The online processing system (20) comprises sub-processes and a data warehouse to receive (40), clean (50), store (60) and process (70) bio-signals into data related to the user's emotions and emotional prediction based on the said emotion at one particular time. The said emotion and said emotional prediction are communicated to the Emotion Transmitter (30) and the Emotion Query System (80) comprising mechanisms to query, retrieve and visualize emotional states and predictions.

The sub process for receiving bio-signals (40) comprises the reception (41) and synchronization (42) of said signals.

The process of cleaning (50) said signals comprises collecting synchronized signals (51), verifying validity of said signals comprising noise management (52) and normalizing said signals (53) to produce valid data.

The process of analyzing data (70) comprises mechanisms to analyze said data in a first phase (71) comprising mechanisms to model said data to estimate user's current emotions and a second phase (72) of analyzes to model said data to estimate a forecast (predictions) of user's emotions considering current and historical records of user's emotional data.

The process of storing valid data (60) in a data warehouse comprises mechanisms to archive valid data (61) comprising bio-signals, current emotions and an emotional forecasting resulting of the process of data analyzes (70).

The online processing system (20) comprises software components utilizing front-web, middle-ware, back-end and other modules and services as well as standard data-base management systems to receive and clean bio-signals into data and process data into emotion information and emotional prediction for that user.

In a preferred embodiment, the Online Processing System (20) constantly gathers new data from one or multiple users, establishes the emotional state (71) for this particular situation or circumstance and produces a forecast (72) for this user for this particular situation or circumstance.

In a preferred and particular embodiment, the Online Processing System (20) processes data from vehicle driver to communicate the driver's current emotional state and a forecast via the Emotion Transmitter (30) to the vehicle so that the vehicle alters content, dynamics, circumstances and variables that affect the vehicle such as speed, radio environment and other elements to procure variations in the dynamics, characters and surroundings of the vehicle to offer a safer driving experience to the driver based on current (71) and predicted (72) emotions.

### D. Emotion Transmitter

Comprises mechanisms to communicate emotions and a prediction of those users being monitored via the Emotion Transmitted (10) and whose emotions current (71) and future (72) have been established and can be transmitted to services, objects, software or any other possible application and/or service that benefits from emotional information being generated.

The Emotion Transmitter (30) comprises software components in the form a applications for electronic telecommunication portable devices communicating a) the current emotional state (71) b) a prediction (72) based on the current and historical emotional states for this user. This data is communicated to the Emotion Transmitter (30) by the Data Analyzer Phase 2 (72) sub component.

The information comprising the emotion and the forecast as transmitted by the Data Analyzer Phase 2 (72) is provided by the online processing system (20) to the Emotion transmitter (30) using wired and wireless communication protocols to enable services, objects or other applications and inventions to keep track of the user's emotions and a forecast for those emotions.

The emotional transmitter (30) comprises embedded software and hardware capable of decoding the information passed by the online processing system (20) to be included in objects, applications, services and any other possible use for recognition of emotional states and predictions based on those emotions.

In a preferred embodiment the Emotional Transmitter (30) is provided as a software added functionality for a vehicle wherein it transmits the current emotion (71) and the prediction (72) based on this emotion to the vehicles on board computer thus making it adaptable to the driver's emotional state.

In a second preferred embodiment the Emotional Transmitter (30) is provided as a software added functionality for a video game wherein it transmits the current emotion (71) and the prediction (72) based on this emotion to the video game engine thus making it adaptable to the user's emotional state.

In other preferred and particular embodiments, the Emotional Transmitter (30) comprises a hardware component with Internet localization mechanisms via an IP (Internet Protocol) address embedded in objects (toys, cars, automatic telling machines, domestic appliances) as added functionality wherein it transmits the current emotion (71) and the prediction (72) based on this emotion to the object thus making it aware to the user's emotional state enabling object's reactions to said emotion (71) and prediction (72).

### E. Bio Signals Receiver

Comprises mechanisms to receive (41) bio-signals from the bio transmitter (10) to synchronize (42) said signals in preparation for subsequent phases of the online processing system (20).

The bio signals receiver (40) is a sub-process of the Online Processing System (20). The bio-signal receiver (40) comprises a receptor (41) receiving raw bio-signals from the bio transmitter (10) and a Data Synchronization (42) sub process.

The Receptor (41) comprises mechanisms to read the bio-signals remotely sent by the bio transmitter (10) to classify them according to origin. Bio-signals origin comprise heart rate, neural activity, electro dermal activity, blood pressure.

The Bio Signal Synchronization sub process (42) comprises mechanisms to organize the bio-signals received by the receptor (41) on the same timeline and express a coherent physiological picture of the user.

In a preferred embodiment, the receptor (41) comprises software components located on a server and its functionalities consist of 1) perpetually receiving bio-signals originated in the bio transmitter (10) and transmitted over the Internet and 2) parse the bio-signals so that packages of similar bio-signals are passed to the Data Synchronization (42) sub process.

In a preferred embodiment, the Data Synchronization (42) sub process is located on a server and comprises software components to 1) receive bio-signals from the receptor (41) and 2) organize the bio-signals originally on different time scales to be expressed on the time scale reflecting a single, constant change over time for unique users.

### F. Bio Signal Cleaner and Data Producer

Comprises mechanisms to collect (51), verify (52) and normalize (53) synchronized bio-signals for unique users to produce valid data for that user ready to be stored (60) and processed (70) by subsequent process of the online Processing System.

The Bio Signal Cleaner and Data Producer (50) is a sub process of the Online Processing System (20) comprising Bio Signals Collector (51), the Bio Signals Verification (52) and the Bio Signals Normalization (53) sub processes.

The Bio Signals Collector (51) is a sub process comprising software components to organize bio-signal fed by the Data Synchronization (41) sub process. The Bio Signals Collector (51) organizes the bio-signals already on the same time line to be processed by the Bio Signals Verification (52) sub process.

The Bio Signals Verification (52) sub process comprises software components that verify the bio-signals received from the Bio Signals Collector (51) contain meaningful and sufficient information including a unique user identifier (UUI) associated to the bio-signals being processed.

The Bio Signals Normalization (53) sub process comprises software components that organize the bio-signals into packets of information ready to be passed to the Data Storage System (61) for storage in the data warehouse.

In a preferred embodiment, the bio-signal cleaner and data producer (50) comprises software components located on a server receiving real time bio-signals from the data synchronization sub component (42).

In a preferred embodiment, the Bio Signals Collector (51) sub process comprises software components that organize the bio-signals already on the same time line as fed by the Data Synchronization sub process (42). In turn, the software components comprising the Bio Signals Collector (51) feed bio-signals to the Bio Signals Verification sub process (52).

In a preferred embodiment, the Bio Signals Verification (52) sub process, comprises software components that verify the data sent by the Bio Signals Collector sub process (51) contains meaningful and sufficient data to be normalized in preparation to be sent to the Bio Signals Normalization sub process (53).

In a preferred embodiment, the Bio Signals Normalization (53) sub process comprises software components that organize the bio-signals fed by the Bio Signals Verification (52) sub process to ensure bio-signals are packed into meaningful data consisting on complete sets of data associated to unique user identifier (UUI) in preparation for organization and storage by the Data Storage System (61).

### G. Data Storage in a Data Warehouse

Comprises mechanisms to store valid data into a data warehouse utilizing standardize data base protocols.

The Data Storage in A Data Warehouse (60) is a sub process of the Online Processing System (20) comprising the Data Storage System (61) and the Data Warehouse (62).

The Data Storage System (61) comprises software components to allow classification and organization of data using standardized and established Data Base principles to process the normalized bio-signals and its associated UUI originating in the Bio Signal Cleaner And Data Producer (50) sub process to be stored in the Data Warehouse (62).

The Data Warehouse (62) comprises standard data base writing and retrieval mechanisms capable of receiving packets of data comprising normalized bio-signals and associate data originating in the Data Storage System (61) and the the Data Analyzer Phase 2 (72). The packets of data comprise comprising the bio-signals and associated UUI originated in the Data Storage System (61) and an emotional state and prediction as fed by the Data Analyser Phase 2 (72). The packets of data are organized by the Data Warehouse (62) in an appropriate structure within the data base. The Data Warehouse (62) also comprises data base retrieval algorithms managing queries from the Data Analyzer Phase 1 (71) and the Emotion Query System (80).

In a preferred embodiment, the Data Storage in a Data Warehouse (60) process comprises software components that receive data originating in the Bio Signal Cleaner and Data Producer (50) and the Data Analyses To Estimate Emotions And Predictions (70) sub processes. The Data Storage in A Data Warehouse (60) also processes queries requested by the Emotion Query System (80). The Data Storage in A Data Ware House (60) sub process also comprises software components to communicate organized data to the Data Analyses To Estimate Emotions And Predictions (70).

In a preferred embodiment, the Data Storage System (61) comprises software components located on a server perpetually receiving data comprising bio-signals and its associated UUI produced by the Bio Signals Normalization (53) sub process. The Data Storage System (61) sub process comprises software components using standardized data base management to classify said bio-signals to find a place in the existing data base structure using UUI as a means to identify the data.

In a preferred embodiment, The Data Warehouse (62) comprises a data base organized considering standardized data base management principles. The Data Warehouse (62) comprises software components to store data on a magnetic medium. Said data comprises the bio-signals originated in the Bio Signals Normalization process (53) and the Data Analyzer Phase 2 (72) both organized considering the UUI. In a preferred embodiment, the bio-signals transmitted by the Bio Signals Normalization (53) sub process is associated to one emotional forecast emitted by the Data Analyzer Phase 2 (72). The emotional forecast is also associated to the UUI. In this preferred embodiment the Data Warehouse (62) also comprises mechanisms to process queries originated in the Emotion Query System (80) to provide a mechanism to visualize the data comprising bio-signals, past, current and forecasted emotions.

### H. Data Analyses to Estimate Emotions and Predictions

Comprises modeling of the data to estimate the user's emotions and a prediction based on these emotions.

The Data Analyses to Estimate Emotions And Predictions (70) comprises software components to associate bio-signals as retrieved from the Data Warehouse (62) and its associated UUI to a) estimate the current emotional state (71) and to b) produce a forecast based on said emotional state. The Data Analyses to Estimate Emotions And Predictions (70) comprises the Data Analyzer Phase 1 (71) sub component and the Data Analyzer Phase 2 (72) sub component.

The Data Analyzer Phase 1 (71) comprises software components based on Artificial Intelligence Algorithms to retrieve bio-signals and its associated UUI information from the Data Warehouse (62) to associate this data with one emotional state. The Data Analyzer Phase 1 (71) component comprises mechanisms to communicate said emotion as identified by modeling Algorithms to the Data Analyzer Phase 2 (72) component.

The Data Analyzer Phase 2 (72) comprises software based on Artificial Intelligence Algorithms to provide a forecast given two sets of data a) the emotion provided by the Data Analyzer Phase 1 (71) and past emotions as retrieved from the Data Warehouse (62). The Data Analyzer Phase 2 (72) comprises mechanisms to communicate the emotional forecast to the Emotion Transmitter (30) and to the Data Warehouse (62) for storage.

In a preferred environment, the Data Analyses To Estimate Emotions and Predictions (70) comprises software components based on Artificial Intelligence to provide for one user (identified with its corresponding UUI) one emotional state based on the bio-signals as retrieved from the Data Warehouse (62) and to provide one forecast given said current emotional state and past emotional states.

In a preferred embodiment the Data Analyzer Phase 1 (71) component comprises Decision Trees, Neural Networks and other Artificial Intelligence Classifiers to discern the emotional state given the bio-signals retrieved from the Data Warehouse (62). The estimation of the Emotion is passed to the Data Analyzer Phase 2 (72) for further analyzes.

The Data Analyzer Phase 2 (72) comprises Hidden Markov Rules, Decision Rules, Bayesian Networks, Decision Trees and other Artificial Intelligence models to estimate the probability of the most likely future emotional state given the current emotional state as passed by the Data Analyzer Phase 1 (71) and previous emotions as retrieved from the Data Warehouse (62). The Data Analyzer Phase 2 (72) process also comprises software components to communicate the current emotional stated fed by the Data Analizer Phase 1 sub-component (71) and the forecast to the Emotion Transmitter (30) and the Data Warehouse (62) for storage.

### I. Emotion Query System

Comprises software components to make queries and process information from the Data Warehouse.

The Emotion Query System (80) comprises software components to query the Data Warehouse (62) about past emotional states stored in the Data Warehouse (62), current emotional states as fed by the Data Analyzer Phase 2 (72) and the forecast as fed by the Data Analyzer phase 2 (72) for one user identified with the UUI.

In a particular embodiment, the Emotion Query System (80) comprises software components to retrieve emotion information for one user identified with the UUI comprising past, current and future emotional states. In this preferred embodiment, the Emotion Query System (80) may be used by other software components, processes, applications or any other invention benefiting from the user's emotions comprising visualization and tracking of emotional change in one user.

### J. Connections of Main Elements and Sub-Elements of Invention

On the one hand, the Bio Transmitter (10) is connected to bio-signals monitoring inventions comprising electro dermal activity (02), cardiac rhythm (03), blood pressure (03), temperature (03), neural activity (04). The connection between the Bio Transmitter (10) and the Bio Sensors is wirelessly enabled and the user may increase or reduce the number of bio-signals employed depending on preferences and availability.

On the other hand, the Bio Transmitter (10) is connected to the Bio Signals Receiver (40) wirelessly via the Internet. The wireless element of this connections enables automatic recognition, storage and transmission of user's emotions in a way that the user may operate normally as he goes about his life.

To enable these connections, the preferred embodiment of the Bio Transmitter (10) is a software component comprising an application (11) running on electronic telecommunication portable devices (31). By doing this, given the Bio transmitter (10) is physically close enough to bio-signals monitoring inventions allowing constant and real time monitoring of the physiological change that the user has. At the same time, the preferred embodiment of the Bio Transmitter (10) is an application (11) for electronic telecommunication portable devices that communicates said bio-signals to the Online Processing System (20) via the Internet.

The Bio Signal Receiver sub process (40) connects to the Bio Transmitter (10) via the application (11) for electronic telecommunication portable devices and the Internet. In particular, the application (11) connects to the Receptor (41) via communication and encryption protocols that enable the safe reception of bio-signals transmitted by the Bio Transmitter (10) and originated in the user's body. The Bio Signal Receiver (40) is located on a server and is not part of the application (11) but its connection to the Bio Transmitter (10) and application (11) represents the input to the Online Processing System (20).

The connection between the Bio Signals Receiver (40) and Bio Signal Cleaner And Data Producer (50) enables the pass of information between the Bio Signals Synchronization (42) and the Bio Signals Collector (51). The data passed between these two sub processes consists of bio-signals.

The connection between the Bio Signal Cleaner And Data Producer (50) and the Data Storage in A Data Warehouse (60) is enabled to pass information between the sub processes. The information passed consists of bio-signals from the Bio Signal Cleaner And Data Producer (50) to be stored on the Data Storage in A Data Warehouse (60).

The Data Storage in A Data Warehouse (60) communicates with the Bio Signal Cleaner And Data Producer (50), the Data Analyses To Estimate Emotion And Predictions (70) and the Emotion Query System (80). On the one hand, the Data Storage in A Data Warehouse (60) receives cleaned and normalized bio-signals from the Bios Signals Cleaner and Data Producer (50) to be stored on the Data Base. On the other hand, the Data Storage in A Data Warehouse (60) receives queries from the Emotion Query System (80) and data in the form of emotional forecast from the Data Analyzer Phase 2 (72) sub process. The queries made by the Emotion Query System (80) consist of past, current and future emotional states for one user.

The Data Analyses To Estimate Emotions And Predictions (70) sub process communicates with the Data Storage in a Data Warehouse (60) and the Emotion Transmitter (30). Data received from the Data Storage in A Data Warehouse (60) comprises bio-signals used to estimate the current emotional state of the user. The Data Analyses To Estimate Emotions and Predictions (70) sub system communicates both the current and future emotional states to the Data Storage in A Data Warehouse (60) system for storage and to the Emotion Transmitter (30) for processing of emotional information.

The data transmitted from the Data Analyses To Estimate Emotions And Predictions (70) system to the Emotion Transmitter (30) represents the output of the Online Processing System (20). This output is transmitted over the Internet to the preferred embodiment of the Emotion Transmitter (30) comprising an application (31) running on an electronic telecommunication portable devices. The output provided by the Online Processing System (20) comprises emotional states past, current and future enabling other applications (311, 312, 313, 314, 315, 316) or objects (317, 318, 319, 320) to exploit this information. The communication between the application (31) and the other applications (311, 312, 313, 314, 315, 316) and/or objects (317, 318, 319, 320) comprises wireless, encrypted communications.

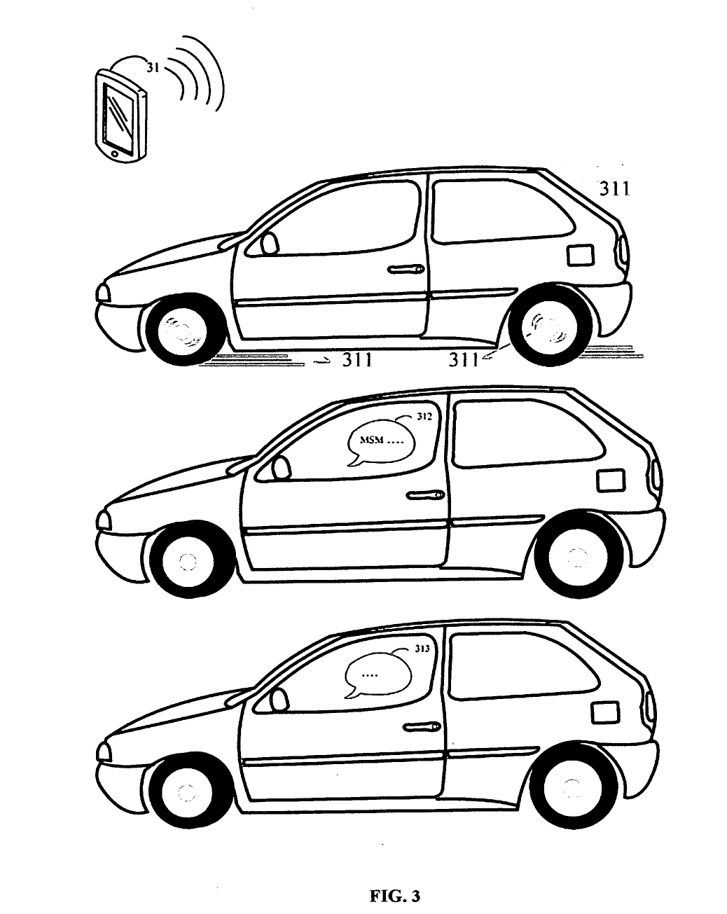

In a first preferred embodiment, the application communicating the emotional states (31) running on an electronic telecommunication portable devices is used by a vehicle (FIG. 3) in a way that variations on the driver's emotions offer the possibility to carry on with the current driving situation, or alter the speed of the car (311) or send a text message (312) or to offer alterations on the background music (313) depending on the risk the driver is in due to his emotions past, current and future. An example of this embodiment would offer alterations on the vehicle considering particularly negative emotions (distraction, stress and tiredness) to offer automatic adjustment on the vehicle such as alterations on the background music. If said emotions pose a danger to the driver then a text message can be sent (312) or the speed of the vehicle can be reduced to keep it at safe levels (311). These variations are defined to enhance the driving experience of the user based on his emotions past present and future.

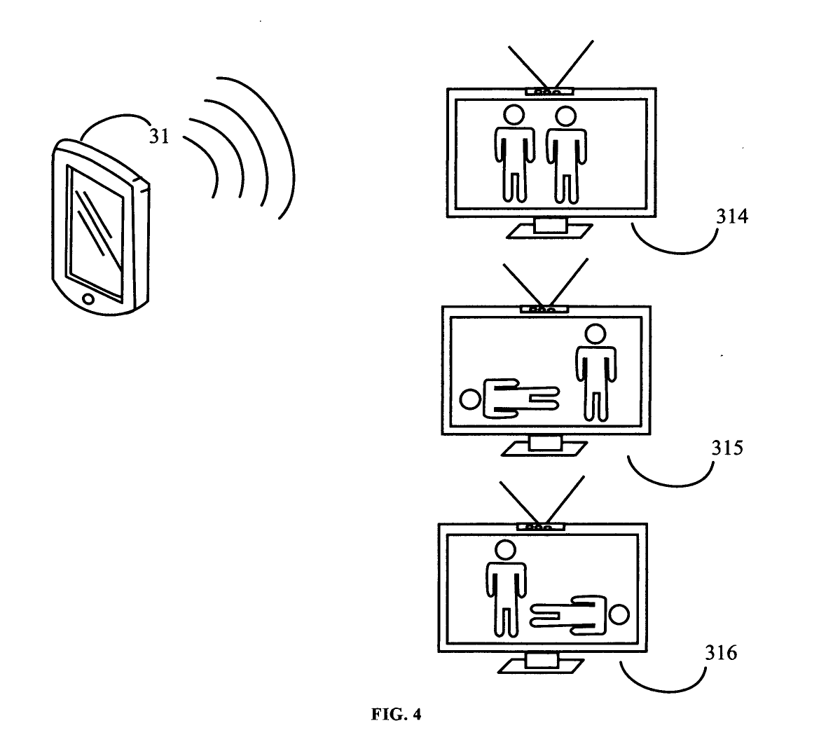

In a second preferred embodiment, the application communicating the emotional states (31) running on an electronic telecommunication portable devices is used by a video game (FIG. 4) in a way that variations on the video game offer the possibility to carry on with the current development of the video game (314) or to alter the development of the game depending on the user's emotions past, current and future (315, 316). An example of this embodiment would offer alterations considering non-playing characters (NPC) display of emotions in line or opposite to the user's emotions, automatic adjustment of game's difficulty or the inclusion of dramatic effects comprising video and audio elements, characterization, colors, musical tones, vibrations on controller among other variations defined to enhance the emotional experience of the user.

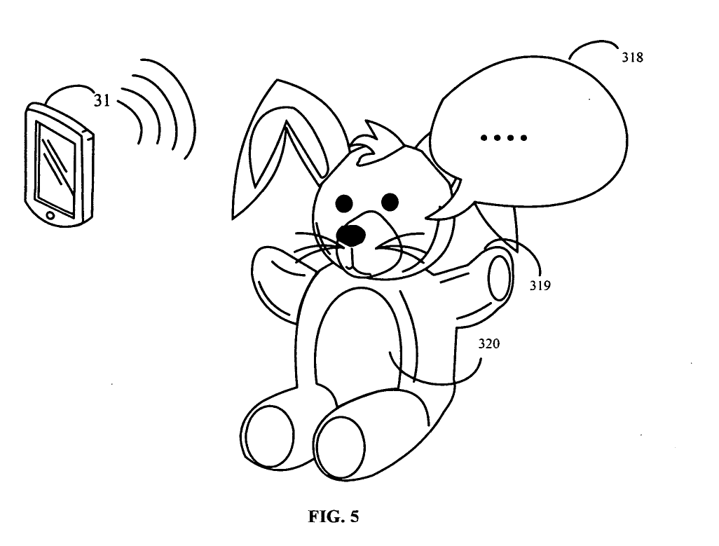

In a third preferred embodiment, the application communicating the emotional states (31) running on an electronic telecommunication portable devices is used by objects comprising stuffed animals (FIG. 5) that automatically utters emotional words (318), moves hands emotionally (320), changes colors (320) or other tactile movements the toy may have depending on the user's emotional state. Other objects that may alter their behavior using emotional states comprise cars, appliances, computers and any other object or device capable of access to the Internet from where it receives past, present and future emotional information of the user interacting with the toy and which behavior can be altered using emotional information and adapting to the desired behavior specified by the user.

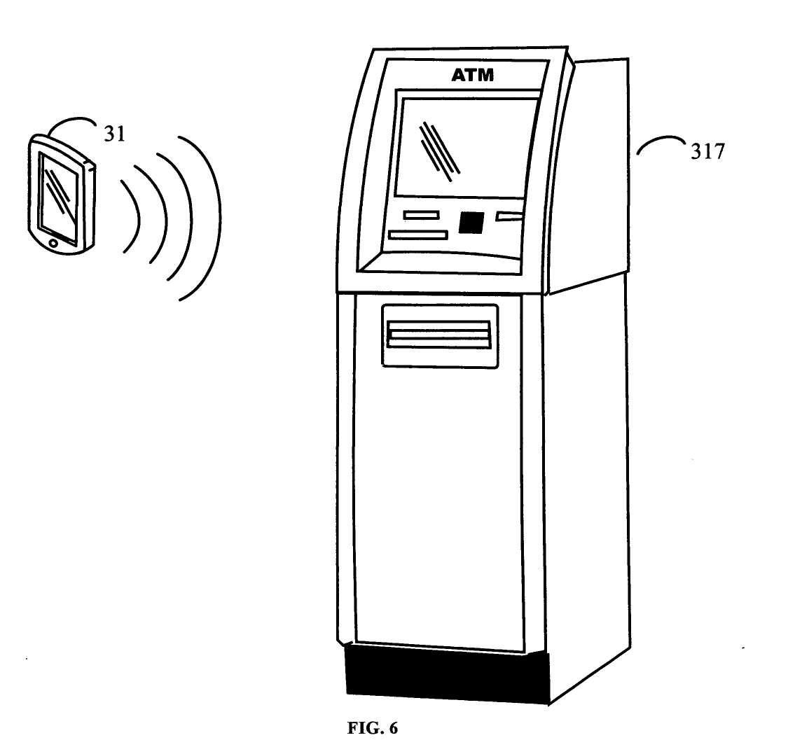

A fourth preferred embodiment of this invention the application communicating the emotional states (31) running on a electronic telecommunication portable devices is used by Automatic Telling Machines or Cash Machines (317) as security mechanisms (FIG. 6). In this invention, the user is asked, along with its card (something the user has) and the PIN number (something the user knows) one third piece of information which is something the user is. Under this view, the user is prompted by the ATM (317) to show a particular emotional state only true and relevant for that user.

Another source for communicating output from the Online Processing System (20) comprises emotional states past, present and future as requested by the Emotion Query System (80) to the Data Storage in A Data Warehouse (60). This communication is supported by the Internet and allows the user to track his emotions.

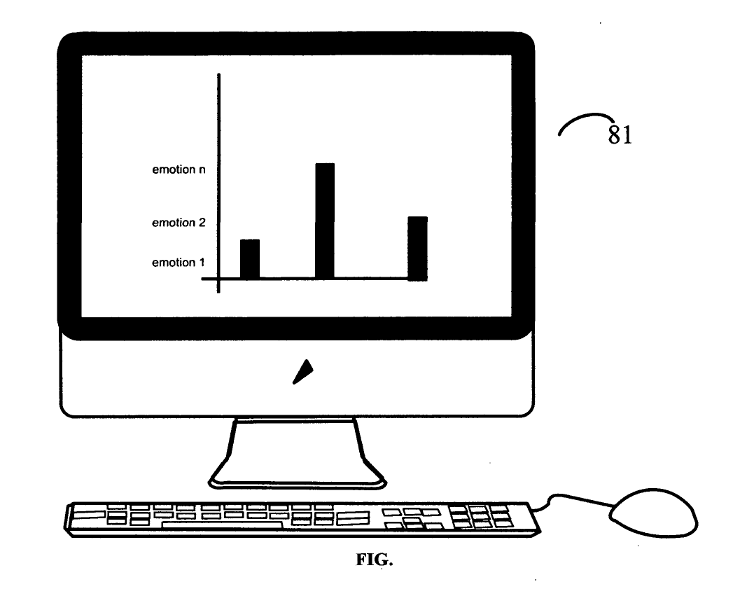

(FIG. 7) in real time (81).

### K. Alternative Embodiments of Invention

The Bio Transmitter (10) may also take the shape of an embedded chip which can be installed on personal objects such as electronic watches, glasses, contact lenses, rings, or any other personal object that the user wears on regular basis.

The Emotion Transmitter (30) may also take the shape of an embedded chip which can be installed objects any toy, car computers, electrical appliances, furniture, clothing or any other object or device with Internet connection that may exploit the user's emotions past current and future.

The Emotion Query System (80) may also take the shape of an online service on which the user can track his emotional states as he goes in his normal life. Additionally, the Emotion Query System (80) may also take the shape of an application for an electronic telecommunication portable devices where the user can also track his emotional states. The Emotion Query System (80) may also comprise tools to allow the user to produce charts of his emotional changes during a particular period of time or during the interaction with particular programs, objects or any other electronic device or web-based application comprising social networks, health care, job performance, military or any other application where emotional information can be exploited.

### L. Operation of Preferred Embodiment

The Best Mode of operation of the System for Automatic Recognition, Storage and Transmission of User's Emotions consists of allowing other inventions, web applications and users to store and track emotions. The best mode implies that the user is wearing, at all times, devices capable of reading physiological information or bio-signals which will be the source data to estimate emotions and an emotional forecast. In the Best Mode of operation, the Bio Transmitter (10) reads information, via an application for an electronic telecommunication portable device (31) which on the one hand collects information related to at least two sources of bio-signals and on the other asks the user the context on which the information is collected for example during the playing of a particular video game.

In the best mode of operation Neural Activity (NA) read via an appropriate device (04) and Electro Dermal Activity (EDA) read using an appropriate device (02) are picked up by the electronic telecommunication portable device's application (31) where the Bio Transmitter is encoded. The Bio Transmitter (30) in turn encrypts the signals and send it over the internet to the Online Processing System (20) located on a centralized server and permanently connected to the Internet. The Receptor (41) is the sub process designed to receive the encrypted information. In the best mode operation, the Receptor (41) uses software components to decipher the information sent by the Bio Transmitter (10) and to separate the information into components. In the best mode operation the data sub components comprise NA and EDA.

Since typical reading frequencies for NA and EDA are different, in the best mode of the invention, these signals need to be synchronized so they are expressed on the same time line. The Receptor (41) sends the data separated in these two components to the Data Synchronization (42) sub process. In the best mode operation, the Data Synchronization (42) comprises software components that, as an example, averages 18 EDA readings (supposing a frequency of 18 data per second) into only one reading per second. Similarly, the Data Synchronization (42) processes NA into one single reading per second. The purpose of doing this is to allow the system to standardize the bio-signals since they may be on different frequencies.

The best mode involves the passing of the NA and EDA already on the same timeline (1 data per second for example) to the Bio Signals Collector (51) sub process which in turn puts the data on appropriate data structures. For example, EDA may consists of information expressed in a non Integer number format whereas NA may consist of information expressed using Integer numbers. The Bio Signal Collector (51) sub process comprises algorithms that identify the bio-signals and puts them in an appropriate data structure. In the best mode for this invention, the data already on the same timeline and in the correct format, is passed to the Bio Signals Verification (52) sub process, along with the unique user identifier (UUI), which verifies the data received from the Bio Signals Collector (51) does not include missing or erroneous data. For example, a reading of the letter “A” for NA when an integer is expected marks this reading as erroneous. A correct reading marks this reading as appropriate. Both erroneous and correct readings are passed along with its corresponding UUI to the Bio Signals Normalization (53).

In the best mode, the Bio Signals Normalization (53) process comprises data transformations, completion of erroneous data and other data normalization techniques to present data in the correct format. For example given that the frequency of data for the EDA is 18 data per second if an erroneous mark is read for this register it could be because there is missing information, for example only 14 readings instead of 18. This loss of information can be due to loss of communication by the Bio Transmitter (10). In the best mode for this invention, the Bio Signals Normalization (53) sub process comprises algorithms that use parameters to estimate the loss of information. If there is a correction at hand, the Bio Signals Normalization (53) sub process will correct the error and normalize the information by averaging 14 pieces of data instead of 18. The Bio Signals Normalization (53) sub process then passes only correct data to the Data Storage in A Data Warehouse (60) process.

In the best mode for this invention, The Data Storage System (61) handles information provided by the Bio Signals Normalization (53) sub process and organizes this information in a Data Base structure. For example, it provides an index for the register containing NA, EDA and UUI information which in the best mode consists of the time of arrival to the Data Storage System (61) as well as the context on which this information is gathered, for subsequent storage on the Data Warehouse (62). In this way, a register for the Data Base comprises the relevant data being read (NA, EDA and UUI in this example) as well as time of arrival and the context on which this data is being generated, for example during the playing of a particular video game.

The best mode for the Data Warehouse (62) comprises a commercial Data Base Management System based on SQL protocols. By using this commercial application it would be easy to store data from the Data Storage System (61) and subsequently, manage information queries made by the Data Analyzer Phase 2 (72) and the Emotion Query System (80). In the best mode of operation, information can be stored for one or multiple users at the same time. Once the register containing NA, EDA and UUI is stored in the appropriate place for one user, the Data Warehouse (62) passes the register containing time, NA, EDA and UUI to the Data Analyzer Phase 1 (71).

In the best mode for this invention, the Data Analyzer Phase 1 (71) utilizes Artificial Intelligence Algorithms comprising Probit models, Decision Trees, Neural Networks and other classification algorithms to determine the emotional state the user is going through at the time of the register and in the context (for example a video game, or interacting with a toy or object) also specified in the register. As a result, in the best mode of operation for this invention, the result of the Data Analyzer Phase 1 (71) comprises one emotional state based on the bio-signals, the time and the context specified in the register passed by the Data Warehouse. This emotional state along with the register is passed to the Data Analyzer Phase 2 (72). In the best mode for this invention, the Data Analyzer Phase 2 (72) sub process uses Artificial Intelligence Algorithms comprising Hidden Markov Chains, Bayesian Networks, Decision Trees and other Artificial Intelligence techniques to estimate a future emotional state. In the best mode of operation, the Data Analyzer Phase 2 (72) queries the Data Warehouse (62) about existing records for this user. If no record for this user is found the Data Analyzer Phase 2 (72) sub process asks the Data Base Manager located in the Data Warehouse (62) to update the register that gave way to the current emotional state with the emotional state for this user, this set of bio-signals and this context. If previous records are found containing emotions, these emotions are used by the Artificial Intelligence algorithms to estimate the most probable future emotion. This prediction is then passed to the Emotion Transmitter (30) along with the current emotion, and a petition to the Data Base Manager is given to store the prediction in the correct register.

In the best mode of operation, the Emotion Transmitter (30) comprises software components expressed in the form of an application for an electronic telecommunication portable device (31). This application will indicate the user which is the most likely emotional state given the current circumstances and past experiences for the same user. Also as the best mode of operation and in a preferred embodiment, the application for the electronic telecommunication portable device (31) communicates the current and future emotional state to other inventions and applications in relation with the context for example a vehicle. The preferred embodiment of this invention thus, allows a vehicle to be adaptable based on real time modeling of the driver emotions. In the second preferred embodiment of the application for electronic telecommunication portable devices (31), the emotion information is passed to objects comprising video games, toys, cars, furniture, electric appliance and other objects that may exploit emotional information.

In the best mode of operation, the Emotion Query System (80) is a web based application that may take the form of another application for electronic telecommunication portable devices, allowing the user to track, visualize and summarize emotional activity for a period of time or during the use of objects or, in the preferred embodiment, during the playing of a video game.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

### INDEX OF ELEMENTS

10: Bio Transmitter
20: Online Processing System
30: Emotion Transmitter
40: Bio Signals Receiver
41: Receptor
42: Bio Signals Synchronization
50: Bio Signal Cleaner And Data Producer
51: Bio Signals Collector
52: Bio Signals Verification
53: Bio Signals Normalization
60: Data Storage in A Data Warehouse
61: Data Storage System
62: Data Ware House
70: Data Analyses To Estimate Emotions And Predictions
71: Data Analizer Phase 1
72: Data Analizer Phase 2
80: Emotion Query System

1. An online method for detecting current emotional states and a prediction of future emotional states based on the input from at least two physiological signals and communicating this information to third party applications, appliances, products and services that exploit said emotions, said method comprises the steps of:
(a) collecting bio signals, from one or multiple bio sensors, generated in one user through a bio transmitter (b) receiving bio signals generated by said bio transmitter, comprises reception of said signals and synchronization of said signals
(c) cleaning bio signals to produce data, comprising synchronization of bio signals, verifying validity of said signals and normalizing said signals to produce valid data (d) storing data in a data warehouse, from where it is possible to retrieve data to characterize and predict emotional states
(e) analyzing said data to estimate user's emotions and a prediction of user's emotions comprising mechanisms to model said data in three phases estimating user's emotions and a predictions of user's emotions (f) storing said emotions and said predictions in said data warehouse
(g) transmitting the emotion and the prediction generated as part of the process comprising the sending of information to any Internet based service, product, applications or inventions that exploit human emotions

2. A bio transmitter comprising mechanisms to collect physiological data and transmit said data to the online method as set forth in claim 1 via any digital or analogical networking using wired or wireless mechanisms to connect to the Internet

3. A method to communicate an emotional state and an emotional forecast based on the online method set forth in claim 1 and comprising an emotion transmitter and an emotion query systems capable of sending said emotional state and forecast via any digital or analogical networking using wired or wireless mechanisms to connect to the Internet.
